(19) United States
(12) Patent Application Publication
(10) Pub. No.: US 2017/0132367 A1
(43) Pub. Date: May 11, 2017

(54) MULTIFARIOUS MEDICAL CONSULTATION OPTIONS OPTIMIZER

(71) Applicant: International Business Machines Corporation, Armonk, NY (US)

(72) Inventors: Theodora H. Cheng, Grand Prairie, TX (US); Tsz S. Cheng, Grand Prairie, TX (US); Tejashkumar B. Purani, Coppell, TX (US)

(21) Appl. No.: 14/936,806

(22) Filed: Nov. 10, 2015

(51) Int. Cl. G06F 19/00; G06N 5/04

(52) U.S. Cl. CPC G06F 19/322; G06F 19/345; G06F 19/325; G06F 19/3481; G06N 5/04

(57) ABSTRACT

A natural language input can be received from a user. A computer-understandable meaning of the natural language input can be derived by performing, by a processor, natural language processing on the natural language input. At least one indicated medical symptom can be identified in the natural language input by processing the computer-understandable meaning of the natural language input using artificial intelligence and, based on the at least one medical symptom, identifying at least one ailment corresponding to the medical symptom. Responsive to identifying the at least one medical symptom, a database of medical consultation options can be accessed to identify a plurality of medical consultation options for treating the at least one ailment and, for each medical consultation option a cost can be identified. A list of the medical consultation options and their costs can be presented to the user.

### BACKGROUND

The present invention relates to processing systems, and more specifically, to healthcare consultation systems.

Access to affordable healthcare is a constant challenge. It can be difficult for people in tight financial situations to get the healthcare they need, especially if they do not have good health insurance. Additionally, with many people working multiple jobs to support their family, it simply is not convenient to spend time commuting to the office of a healthcare provider and waiting long periods of time to see a doctor. Even if one has the financial means to visit a doctor and can take time off from work to see a doctor, he or she may not be able to secure an appointment within a reasonable time frame. As a result, some people may postpone seeking medical care until medical conditions become more severe or unbearable.

Medical care providers sometimes offer different delivery methods and price levels for medical care consumers to select from. For example, some healthcare providers use nurse practitioners to see patients. Also, some healthcare providers have walk-in clinics to provide medical care at accommodating times and locations. These types of clinics allow people to access a physician or nurse practitioner at hours that typical doctor offices are not open at (i.e. after office hours and/or on weekends). Pricing for such services, however, can vary greatly. Further, some healthcare providers offer remote consultation (e.g., video or voice chats) via smartphone applications. These video chats are convenient, allowing for patients to have access to a doctor or registered nurse at any time without having to waste time commuting or waiting to see a doctor. The costs for these remote medical services typically are lower than an office visit, albeit with tradeoffs such as not being able to receive physical examination and measurement. Nonetheless, it can be difficult for some medical care consumers to determine what level of care they need, and the most cost effective way at getting that care.

### SUMMARY

A method includes receiving, from a user, a natural language input. The method also includes deriving a computer-understandable meaning of the natural language input by performing, by a processor, natural language processing on the natural language input. The method also includes identifying in the natural language input at least one indicated medical symptom by processing the computer-understandable meaning of the natural language input using artificial intelligence and, based on the at least one medical symptom, identifying at least one ailment corresponding to the medical symptom. The method also includes, responsive to identifying the at least one medical symptom, accessing at least a first database of medical consultation options, identifying within the first database of medical consultation options a plurality of medical consultation options for treating the at least one ailment and, for each medical consultation option, identifying a cost of the medical consultation option. A list of the identified plurality of medical consultation options and, for each medical consultation option, the cost of the medical consultation option can be presented to the user. In one arrangement, presenting to the user the list of the identified plurality of consultation options can include presenting to the user a list of healthcare providers. Presenting to the user the list of healthcare providers can include presenting, for each healthcare provider, an indication of a type of consultation delivery. Accordingly, the user can choose the medical consultation option and medical consultation provider that best suits the user's needs and budget.

The method also can include, responsive to identifying in the natural language input at least one ailment, prompting the user to enter additional information to symptoms experienced by the user and medical history of the user, and processing the additional information using the artificial intelligence. Based on identifying in the natural language input at least one ailment and processing the additional information using the artificial intelligence, a medical case data file for the user, the medical case data file can be automatically generated for the user. The medical case data file can include the at least one ailment and the additional information. The medical case data file can serve as a location to store the user's information, thus facilitating the process of recommending medical consultation and medical service providers to the user.

The method also can include identifying a location of the user and, responsive to identifying the location of the user, accessing climate data indicating a climate at the location. The medical case data file can further include the information indicating the climate at the location. Accordingly, this information can be considered when determining recommendations for medical consultation for the user. For example, if the user lives in a cold climate, the user may be prone to certain types of ailments.

The method also can include identifying a location of the user and, responsive to identifying the location of the user, identifying at least one disease outbreaks within a particular distance of the location by accessing at least a second database of disease outbreaks. The medical case data file further can include information indicating the at least one disease outbreak. Accordingly, this information can be considered when determining recommendations for medical consultation for the user. For example, if there is a particular disease outbreak in the region where the user lives, and the user's symptoms correspond to that disease, that disease can be identified as being an ailment the user potentially has.

The method also can include identifying a plurality of other users afflicted by the ailment and presenting to the user and the plurality of other users an option to collectively purchase at least one of the identified plurality of consultation options. For example, the users can be offered a discount to collectively purchase the consultation options. This can save money for users who need such consultations.

A system includes a processor programmed to initiate executable operations. The executable operations include receiving, from a user, a natural language input. The executable operations also include deriving a computer-understandable meaning of the natural language input by performing natural language processing on the natural language input. The executable operations include identifying in the natural language input at least one indicated medical symptom by processing the computer-understandable meaning of the natural language input using artificial intelligence and, based on the at least one medical symptom, identifying at least one ailment corresponding to the medical symptom. The executable operations include, responsive to identifying the at least one medical symptom, accessing at least a first database of medical consultation options, identifying within the first database of medical consultation options a plurality of medical consultation options for treating the at least one ailment and, for each medical consultation option, identifying a cost of the medical consultation option. A list of the identified plurality of medical consultation options and, for each medical consultation option, the cost of the medical consultation option can be presented to the user. In one arrangement, presenting to the user the list of the identified plurality of consultation options can include presenting to the user a list of healthcare providers. Presenting to the user the list of healthcare providers can include presenting, for each healthcare provider, an indication of a type of consultation delivery. Accordingly, the user can choose the medical consultation option and medical consultation provider that best suits the user's needs and budget.

A computer program includes a computer readable storage medium having program code stored thereon. The program code is executable by a processor to perform a method. The method includes receiving, by the processor, from a user, a natural language input. The method also includes deriving a computer-understandable meaning of the natural language input by performing, by the processor, natural language processing on the natural language input. The method also includes identifying, by the processor, in the natural language input at least one indicated medical symptom by processing the computer-understandable meaning of the natural language input using artificial intelligence and, based on the at least one medical symptom, identifying at least one ailment corresponding to the medical symptom. The method also includes, responsive to identifying the at least one medical symptom, accessing, by the processor, at least a first database of medical consultation options, identifying, by the processor, within the first database of medical consultation options a plurality of medical consultation options for treating the at least one ailment and, for each medical consultation option, identifying, by the processor, a cost of the medical consultation option. A list of the identified plurality of medical consultation options and, for each medical consultation option, the cost of the medical consultation option can be presented to the user. In one arrangement, presenting to the user the list of the identified plurality of consultation options can include presenting to the user a list of healthcare providers. Presenting to the user the list of healthcare providers can include presenting, for each healthcare provider, an indication of a type of consultation delivery. Accordingly, the user can choose the medical consultation option and medical consultation provider that best suits the user's needs and budget.

### BRIEF DESCRIPTION OF THE DRAWINGS

FIG. 1 is a block diagram illustrating an example of a computing environment.

FIG. 2 is a diagram illustrating an example of a view of user interface presenting to a user a plurality of medical care options.

FIG. 3 is a flow chart illustrating an example of a method of presenting to a user a list of a plurality of medical consultation options.

FIG. 4 is a block diagram illustrating example architecture for a data processing system.

### DETAILED DESCRIPTION

This disclosure relates to processing systems, and more specifically, to health care consultation systems. In accordance with the inventive arrangements disclosed herein, a processing system can receive from a user natural language input describing an ailment, or symptoms of an ailment, being experienced by the user or another user. The processing system can perform natural language processing (NLP) on the natural language input to derive a computer-understandable meaning of the user's natural language input, and guide the user through creating a medical case data file for the user. The processing system can use artificial intelligence to identify the ailment by processing the information gathered in the medical case data file, as well is various information accessed from other external systems. Further, the processing system can identify consultation options for treating the ailment and, for each consultation option, identify an associated cost. By way of example, for each consultation option, the processing system can identify other information, such as a consultation provider, a type of consultation provided by the consultation provider, a type of consultation delivery, a service description, etc. The processing system can present each consultation option, as well as the cost and other information, to the user in a list. Accordingly, the user can peruse the list and select a consultation option that best suits the user's needs.

In addition, the processing system can identify a plurality of users who may have the same ailments or otherwise exhibit the same symptoms. The processing system can provide to each of such users an option to purchase consultation at a group rate. In illustration, if numerous users located in a particular geographic region (e.g., village, town or city) each have the influenza, or exhibit symptoms of having the influenza, the processing system can provide to each of those users an option to visit a particular medical consultation facility (or medical practitioner) that will provide consultation for a discounted rate. Such an arrangement not only can save money for the user's requiring consultation, but also can provide increased revenues for the medical consultation facility by attracting more patients to that facility. Moreover, since the medical consultation facility will be treating a large number of patients each having the same ailment and/or symptoms, the medical consultation facility can streamline consultation procedures and potentially purchase significant quantities of medications at a discounted volume rate.

Several definitions that apply throughout this document now will be presented.

As defined herein, the term “ailment” means a sickness or disease present in a person.

As defined herein, the term “symptom” means subjective evidence of a sickness or disease present in a person.

As defined herein, the term “consultation option” means at least one of a plurality of consultations available to discuss an ailment, treat an ailment and/or provide treatment recommendations.

As defined herein, the term “consultation delivery” means a way of prescribing a consultation for an ailment.

As defined herein, the term “medical consultation” means a review of a user's medical condition, which may include reviewing the user's medical symptoms and/or medical history, to make a recommendation of a treatment for the medical condition. A medical consultation also may include treating the user's medical condition and/or prescribing a treatment for the user's medical condition.

As defined herein, the term “medical case selfie” means an electronic medical case data file created for a user by guiding, by a processing system, the user to answer one or more questions relating to the user's medical condition.

As defined herein, the term “natural language” means a human written or spoken language. Examples of a natural language include, but are not limited to, English, Russian, German, French, Italian, Japanese, Korean, and the like. As the term “natural language” is defined herein, a computer programming language is not a “natural language.” As the term “natural language” is defined herein, an artificial command is not a “natural language.”

As defined herein, the term “natural language input” means information generated by a person using a natural language, which is received by a processing system.

As defined herein, the term “computer-understandable meaning” means computer data generated by a processing system that represents a meaning of a natural language input and is configured to be processed by the processing system or another processing system.

As defined herein, the term “artificial intelligence” means a simulation, performed by a processing system, of human intelligence.

As defined herein, the term “responsive to” means responding or reacting readily to an action or event. Thus, if a second action is performed “responsive to” a first action, there is a causal relationship between an occurrence of the first action and an occurrence of the second action, and the term “responsive to” indicates such causal relationship.

As defined herein, the term “computer readable storage medium” means a storage medium that contains or stores program code for use by or in connection with an instruction execution system, apparatus, or device. As defined herein, a “computer readable storage medium” is not a transitory, propagating signal per se.

As defined herein, the term “client device” means a device or system comprising at least one processor and memory used by a user. Examples of a client device include, but are not limited to, a workstation, a desktop computer, a mobile computer, a laptop computer, a netbook computer, a tablet computer, a smart phone, a personal digital assistant, a smart watch, smart glasses, a gaming device, a set-top box, and the like.

As defined herein, the term “healthcare consultation system” means a device or system comprising at least one processor and memory that executes an application configured to identify a list of a plurality of healthcare consultation options for at least one ailment. Examples of a healthcare consultation system, but are not limited to, a server, a plurality of communicatively linked servers, and the like.

As defined herein, the term “processor” means at least one hardware circuit (e.g., an integrated circuit) configured to carry out instructions contained in program code. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, the term “real time” means a level of processing responsiveness that a user or system senses as sufficiently immediate for a particular process or determination to be made, or that enables the processor to keep up with some external process.

As defined herein, the term “output” means storing in memory elements, writing to display or other peripheral output device, sending or transmitting to another system, exporting, or the like.

As defined herein, the term “automatically” means without user intervention.

As defined herein, the term “user” means a person (i.e., a human being).

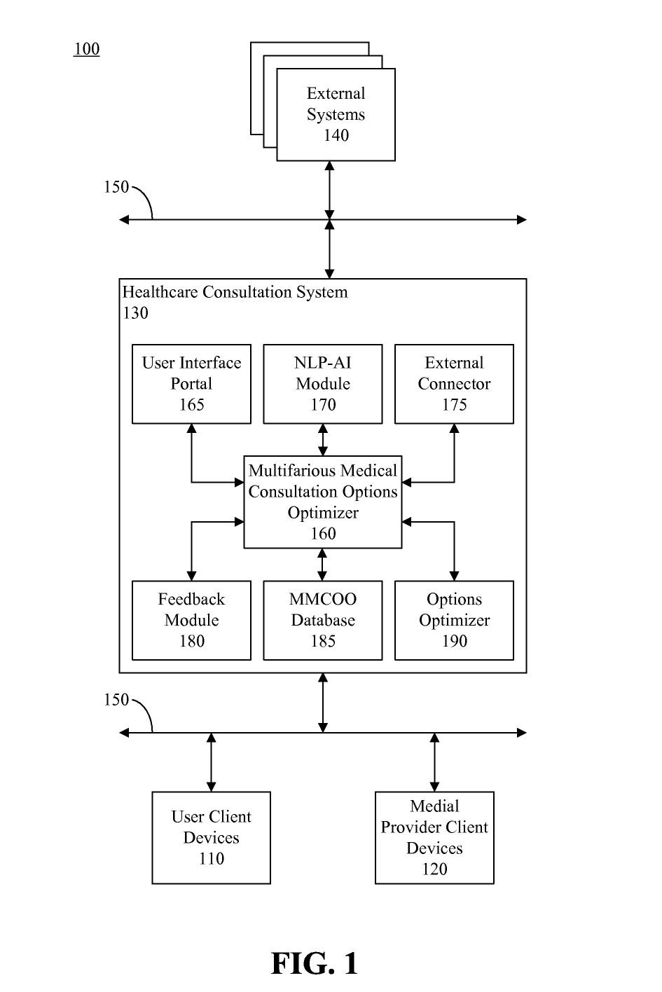

FIG. 1 is a block diagram illustrating an example of a computing environment 100. The computing environment 100 can include one or more client devices 110, 120 communicatively linked to a healthcare consultation system 130, for example client devices 110 used by users and client devices 120 used by healthcare providers. Further, the computing environment can include a plurality of external systems 140, each of which includes at least one processor and memory, to which the healthcare consultation system 130 is communicatively linked. Examples of the external systems 140 include, but are not limited to, government healthcare program systems, insurance provider systems, public health information systems, sensor systems, healthcare rating/review systems, healthcare pricing model systems, environmental information systems, sensor systems, and payment processing systems. One or more of the external systems 140 can host databases storing various types of data accessed by the healthcare consultation system 130 and/or applications with which the healthcare consultation system 130 interfaces, examples of which will be described.

The client devices 110, 120 and external systems 140 can be communicatively linked to the healthcare consultation system 130 via at least one communication network 150. The communication network 150 is the medium used to provide communications links between various devices and data processing systems connected together within the computing environment 100. The communication network 150 may include connections, such as wire, wireless communication links, or fiber optic cables. The communication network 150 can be implemented as, or include, any of a variety of different communication technologies such as a WAN, a LAN, a wireless network, a mobile network, a Virtual Private Network (VPN), the Internet, the Public Switched Telephone Network (PSTN), or the like.

The healthcare consultation system 130 can include a multifarious medical consultation options optimizer (MMCOO) 160, a user interface portal 165, a natural language processing and artificial intelligence (NLP-AI) module 170, an external connector 175, a feedback module 180 an MMCOO database 185 and an options optimizer 190. The MMCOO 160 can be configured to process various inputs and access various data to guide a user through creating a medical case data file for the user (“medical case selfie”), identify one or more ailments experienced by the user, identify consultation options for the ailment(s), identify costs for various consultation options, etc. The user interface portal 165 can be, for example, a web portal via which users of the client devices 110, 120 access the healthcare consultation system 130.

The NLP-AI module 170 can receive natural language user inputs, either as text or spoken utterances, and implement natural language processing (NLP) and semantic analysis on information contained in the natural language inputs to derive a computer-understandable meaning of the natural language inputs. NLP is a field of computer science, artificial intelligence and linguistics which implements computer processes to facilitate interactions between computer systems and human (natural) languages. NLP enables computers to derive computer-understandable meaning from natural language input. The International Organization for Standardization (ISO) publishes standards for NLP, one such standard being ISO/TC37/SC4. Semantic analysis is the implementation of computer processes to generate computer-understandable representations of natural language expressions. Semantic analysis can be used to construct meaning representations, semantic underspecification, anaphora resolution, presupposition projection and quantifier scope resolution, which are known in the art. Semantic analysis is frequently used with NLP to derive computer-understandable meaning from natural language input. The NLP-AI module 170 also can process the computer-understandable meaning of the natural language inputs using artificial intelligence to derive various types of information.

The external connector 175 can be a module configured to, at the behest of the MMCOO 160, access and receive information from the external systems 140 and communicate the information to the MMCOO 160. For example, the external connector 175 can send requests (e.g., http requests) querying the external systems 140 for desired information. The feedback module 180 can be configured to provide feedback, recommendations, etc. to the user. The MMCOO database 185 can contain medical case selfies generated for various users, as well as other data used by the various components of the healthcare consultation system 130. The options optimizer 190 can be configured to select various medical consultation options identified by the MMCOO 160 which are most relevant to the user.

In one aspect of the present arrangements, the healthcare consultation system 130 can be implemented using International Business Machines Corporation's Watson Ecosystem, or one or more of the components 165-190 can be implemented using the Watson Ecosystem. For example, the Watson ecosystem can be used to implement the functionality of the NLP-AI module 170, external connector 175, feedback module 180, MMCOO database 185 and the options optimizer 190. Watson is an artificially intelligent computer system capable of answering questions posed in natural language

In operation, a user of the client device 110 can connect the client device 110 to the user interface portal 165. In response, the user interface portal 165 can communicate to the client device 110 one or more web pages (or other user interface screens) to be presented to the user, for example via a web browser or other application executing on the client device 110. Via the web page(s) (or screens), the user can be prompted to enter various types of information about the user, for example a user name, age, location, medical insurance information (e.g., insurance provider, policy number, etc.), and the like. Responsive to receiving this information, the MMCOO 160 can create a data file for a medical case selfie for the user. At this point it should be noted that although the examples described herein relate to a user creating a medical case selfie for himself/herself and being presented a plurality of medical consultation options, a user also can create a medical case selfie for another person, for example a spouse, child, parent, etc., and can be presented a plurality of medical consultation options for that other person, and such an example is within the scope of the present arrangements.

Check boxes can be provided on the web page(s) prompting the user to identify the user's medical history, for example pre-existing medical conditions the user may have, diseases the user and/or relatives of the user have or have had, etc. The user can be prompted to enter natural language inputs describing his/her pre-existing medical conditions or select checkboxes from a list of conditions/diseases. The user's medical history can be added to the medical case selfie. In the case that the user's medical history is indicated using natural language, the NLP-AI module 170 can process the natural language input to derive a computer-understandable meaning of the natural language input and, based on the computer-understandable meaning, identify the user's medical history. Further, based on information processed by the NLP-AI module 170, the NLP-AI module 170 can derive additional questions that may be relevant to the user's medical history. For example, if the user indicates that the user has, or has had, allergies, the NLP-AI module 170 can derive a question asking the user to indicate the allergens to which the user is allergic, and the feedback module 180 can present the question to the user via the web page. The NLP-AI can process the user's answers to the questions and add results of such processing to the user's medical case selfie. The process can continue until the MMCOO 160 and/or NLP-AI module 170 determines that sufficient information regarding the user's medical history has been obtained.

Further, the web page(s) can prompt the user to enter natural language inputs describing symptoms he/she is experiencing, one or more ailments the user thinks he/she may have, and/or the like. The NLP-AI module 170 can process such natural language input to derive a computer-understandable meaning of the natural language input and, based on the computer-understandable meaning, identify the symptoms experienced by the user. Using artificial intelligence, the NLP-AI module 170 can identify one or more ailments that correspond to those symptoms. In making such identification, the NLP-AI module 170 also can consider the one or more ailments the user thinks he/she may have, pre-existing medical conditions of the user, as well as other information. The identified ailments can be added to the medical case selfie for the user.

In one aspect, a derived question generated by the healthcare consultation system 130 may ask the user to provide one or more documents, images and/or videos. For example, if the symptoms indicated by the user indicate skin irritation, the derived question can request the user to provide an image of the afflicted area. Responsive to receiving the documents, images and/or videos, the NLP-AI module 170 can analyze such to determine one or more symptoms and/or ailments indicated in the documents, images and/or videos, and the MMCOO 160 can add corresponding information to the user's medical case selfie. To process images and/or videos, the NLP-AI module 170 can include, or access, image processing software, which is known in the art. If processing of the documents, images and/or videos by the NLP-AI module 170 is indeterminate, the healthcare consultation system 130 can electronically communicate such to a medical practitioner for further evaluation. Information received from the medical practitioner can be added to the user's medical case selfie.

At least some other information can be accessed from one or more of the external systems 140. For example, at the behest of the MMCOO 160, the external connector 175 can access one or more public health information databases to access information regarding disease outbreaks, influenza tracking, etc., within proximity to the user's location (e.g., within a particular distance from the user's location), for example within a village, town, city, county, state, province or country the user is located. Such information can be added to the user's medical case selfie. If the user's symptoms correspond to any such diseases, such diseases can be identified by the NLP-AI module 170, and perhaps given a greater weighting for analysis than otherwise would be assigned to such diseases. In illustration, if the symptoms explained by the user correspond to influenza, and there is an outbreak of a particular form of influenza in the user's geographic region, the MMCOO 160 can determine that the user may have that form of influenza.

In another example, at the behest of the MMCOO 160, the external connector 175 can access an environmental information system and/or one or more sensor systems to access information regarding environmental conditions of the location where the user is located, for example climate information (e.g., temperature, humidity, precipitation, wind strength, altitude, etc.), information pertaining to levels of particulates in the air due to smog, dust, etc., information pertaining to toxic waste and/or toxic spills, information related to soil contamination, and the like. Such information also can be processed by the NLP-AI module 170 as data inputs used to identify one or more ailments which the user may be suffering, and such information can be added to the user's medical case selfie.

In another example, the NLP-AI module can access from the MMCOO database 185 medical case selfies of people who are close to the user, for example relatives of the user, friends of the user, co-workers of the user, etc. In such an arrangement, each user can be asked to indicate whether they authorize their medical case selfies to be accessed to aid in diagnosing other users. In this regard, the MMCOO 160 can prompt the user to identify names of people who are close to the user, and the MMCOO 160 can correlate those names to medical case selfies stored in the MMCOO database 185. For each identified name for which there is a medical case selfie and that person has authorized the medical case selfie to be used for diagnosing other users, the MMCOO 160 can access the medical case selfie and provide pertinent information from such to the NLP-AI module 170 for processing, along with the other previously described information, to identify one or more ailments from which the user may be suffering. Moreover, the MMCOO 160 can add pertinent information from the other medical case selfies to the user's medical case selfie.

Moreover, the MMCOO 160 can, agnostic to various users, process the medical case selfies of the various users when determining, for any particular user, one or more ailments. For example, the MMCOO 160 can process other medical case selfies to identify various similarities between other people and a particular user (e.g., symptoms, location, age, occupation, etc.) and, based on those similarities, update the user's medical case selfie and/or process such information to identify one or more ailments that the user may be suffering. Thus, analysis of the user's medical case selfie can take into consideration not only information of the user, but also information of other users that is relevant to the user's current ailment(s).

In some instances the user may already have a medical case selfie stored in the MMCOO database 185, for example based on the user's previous interactions with the healthcare consultation system 130. In one arrangement, rather than creating a new medical case selfie, the MMCOO 160 can update the user's existing medical case selfie with the information described herein. For example, responsive to the user logging into the healthcare consultation system 130, the MMCOO 160 can prompt the user to indicate whether the user is adding information regarding new symptoms or a new ailment, or providing further information for symptoms or an ailment the user has previously described to the healthcare consultation system 130. The MMCOO 160 can organize the data in the medical case selfie accordingly.

The MMCOO 160 and NLP-AI module 170 can process the user's medical case selfie to determine an initial medical consultation for the user and/or a recommendation for further medical consultation. For example, the NLP-AI module 170 can process the user's medical case selfie and, based on the user's medical case selfie, access information from the MMCOO database 185 and/or the external systems 140 to retrieve information related to the user's symptoms and/or self indicated ailment. The NLP-AI module 170 can process the accessed information and the user's medical case selfie to determine one or more ailments the user most likely is, or is, suffering from. For example, the NLP-AI module 170 can access a database of medical consultation options and identify those medical consultation options corresponding to the ailment(s). The NLP-AI module 170 can communicate such determination to the MMCOO 160. The MMCOO 160 can access information from the MMCOO database 185 and/or the external systems 140 and process such information, along with the determination of the NLP-AI module 170, to determine an initial medical consultation and/or recommendation for further medical consultation for such ailment(s).

The MMCOO 160 can provide to the user, via the web page(s), the determined initial medical consultation and/or recommendation for further medical consultation. For example, as an initial medical consultation, the MMCOO 160 can recommend to the user to get enough sleep and to take one or more particular medications available without a prescription. In another example, if a user is suffering from an ear infection, the MMCOO 160 can determine that the user should immediately seek in person medical consultation from a medical practitioner. In a further example, if the user is suffering from a skin rash, the MMCOO 160 can determine that the user may seek remote/asynchronous medical consultation. If the MMCOO 160 determines that the user should consult a medical practitioner, or the user requests to do so, the MMCOO 160 can provide to the user a list of medical practitioners within a particular distance of the user's location, a recommended consultation type, a type of medical service delivery (e.g., video, telephone, e-mail, text messaging, in person, etc.), and a cost of the medical service delivery.

In the case that the MMCOO 160 determines that the user should consult a medical practitioner, and recommends a list of medical facilities and/or medical practitioners, the options optimizer 190 can process various information to filter and/or sort options presented in the list. For example, the options optimizer 190 can initiate the external connector 175 to obtain insurance coverage information from the user's medical insurance provider based on the user's insurance policy number. The insurance coverage information may indicate preferred medical facilities/practitioners who have a negotiated rate for providing medical service to the user. Thus, the options optimizer 190 can limit the list to those medical facilities/practitioners, or sort the list so that such medical facilities/practitioners are indicated as being preferred medical facilities/practitioners (e.g., they are presented at the top of the list). Moreover, for each medical facility/practitioner, the negotiated rate for treating the determined ailment(s) can be listed.

The options optimizer 190 also can filter and/or sort medical consultation options based on selection criteria provided by the user. For example, the MMCOO 160 can prompt the user to enter selection criteria, and that criteria can be saved to the user's medical case selfie. The options optimizer 190 can process the selection criteria to select recommended consultation types and/or types of medical service delivery corresponding to the selection criteria. In illustration, the user can specify a criteria indicating that the user desires lowest cost options for medical consultation, criteria indicating that the user desires medical consultation at certain times and/or on certain days (e.g., after normal work hours and/or on weekends), criteria indicating that the user desires the nearest providers of medical consultation, etc. Moreover, the user can specify criteria after a list of medical facilities and/or medical practitioners already has presented to the user. For example, the user can peruse the list and, responsive to determining a narrower list of options is desired, the user can enter criteria to be used by the options optimizer 190 to filter the list further, for example based on cost, distance from the user, type of medical consultation desired by the user, etc.

Healthcare providers (e.g., medical facility staff and/or practitioners) can interact with the MMCOO 160 via their respective client devices 120, using the user interface portal 165, to participate in medical consultations recommended by the MMCOO 160. In illustration, healthcare providers can provide to the MMCOO 160 their name, location information, a list of various medical consultation services provided, and respective costs. The costs can include individual costs for consulting/treating one person, group costs for consulting/treating a group of people, and shared costs for consulting/treating a group of people who all exhibit the same medical symptoms. The costs also can include costs agree upon by the healthcare providers to provide medical consultation to patients having one or more medical insurance providers. The healthcare providers also can specify the methods of payment they accept, their hours of operation and indicate whether they are available after normal business hours and/or on weekends. Further, the medical facilities and/or practitioners can indicate the modes of patient communication they support, for example in person, telephonic communication, video communication, e-mail communication, text messaging, etc.

By way of participating in the offering of services via the healthcare consultation system 130, healthcare providers can increase their number of patients, thus increasing their revenue and, perhaps, utilizing otherwise under-utilized consultation capacity. Moreover, healthcare providers can provide video, phone and/or e-mail consultation to patients who may not be located in same geographic regions as the healthcare providers, which also can help to expend their number of patients, while providing convenience to users who can receive consultation without having to travel to a medical facility. Further, buy offering group buys and group sharing of healthcare consultation services, healthcare providers can streamline their services. For example, a medical practitioner can consult/treat a plurality of patients, all exhibiting the same symptoms, within a particular time frame. Further, medications to treat the patients can be purchased in bulk quantities. Thus, the healthcare providers can negotiate discounts from the vendors of those medications.

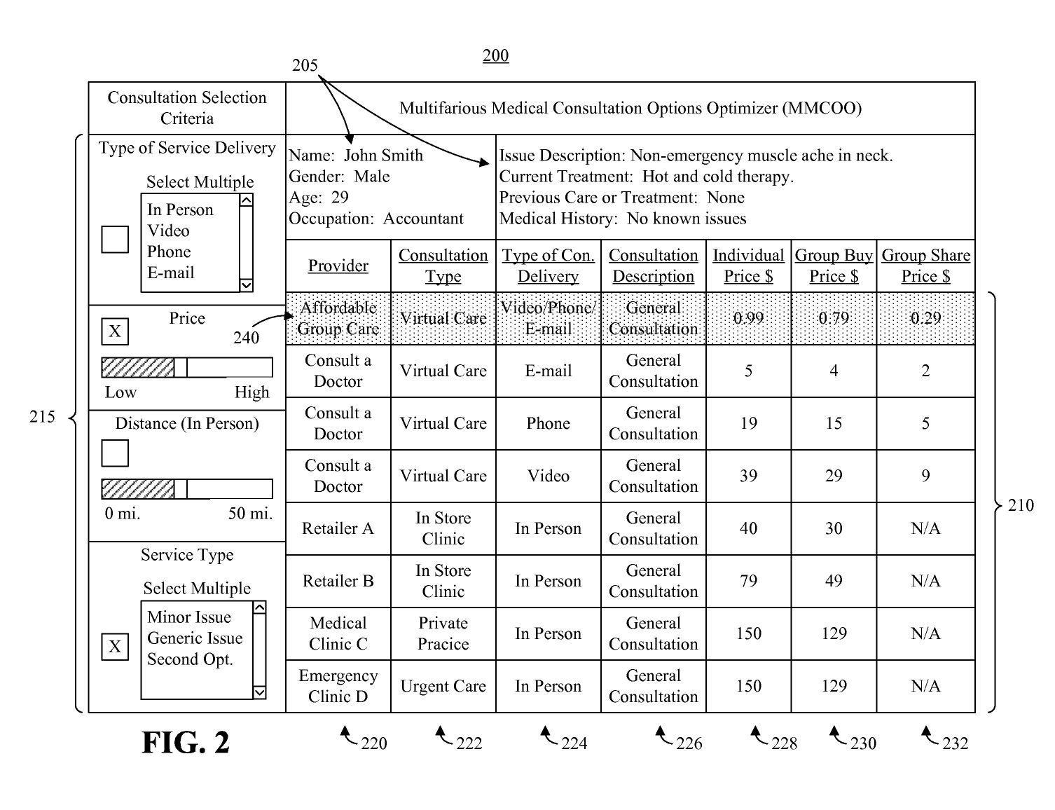

FIG. 2 is a diagram illustrating an example of a view 200 of a user interface presenting to a user a plurality of medical care options. The view can be presented by the MMCOO 160 via a user interface of a client device 110 (e.g., via the user interface portal 165). The view 200 can present to the user information 205 contained in the user's medical case selfie, various options 210 for medical consultation, and various user selection criteria 215.

The user information 205 can include information obtained from the user, as previously described. For example, the user information 205 can include a user name, gender, age, occupation, etc. The user information 205 also can include various other information derived from the user's inputs by performing NLP and artificial intelligence processing of the user's inputs. Such other information can include a description of the user's present medical condition, current treatments being applied by the user, previous treatments which may have been applied to the user and medical history information of the user.

The various options 210 for medical consultation can include those options determined by the MMCOO 160 and/or options optimizer 190 as previously described. For example, the various options 210 can include a table including a plurality of columns and rows. Each row can include information corresponding to a respective medical consultation recommendation. For example, each row can include a field 220 indicating a provider of a medical facility/practitioner, a field 222 indicating a medical consultation type, a field 224 indicating a type of medical consultation delivery, a field 226 indicating a medical consultation description, a field 228 indicating a price for providing the medical consultation to the user as an individual, a field 230 indicating a price for providing the medical consultation to the user as part of a group buy by a plurality of users, and a field 232 indicating a price for providing the medical consultation to the user as part of a group sharing by a plurality of users.

In the case of a group buy, a plurality of users may be provided an option to select a particular medical consultation facility/provider, irrespective of their individual medical needs, to obtain a group discount on medical consultation. In the case of a group sharing, users who each exhibit the same medical symptoms may be presented an option to select a particular healthcare provider to collectively purchase medical consultation and obtain a group discount on the consultation based on those same medical symptoms. For example, if a plurality of user's have symptoms of influenza, those users can be presented an option to purchase medical consultation, as a group, for influenza. Healthcare providers can benefit from participating in such group buys and group sharing since such actions may increase their volume of patients.

The user selection criteria 215 can include various fields with which the user may interact to specify various criteria for filtering the various options 210. Information obtained from the user in such fields can be stored to the user's medical case selfie. Further, such information can be processed by the options optimizer 190 to filter the various options 210 for medical consultation, and the various options 210 can be updated by the MMCOO 160 responsive to the user inputting such information. Thus, the user can adjust the user selection criteria 215 to refine his/her search for medical consultation.

The various fields can include, for example, a field in which the user can specify one or more types of medical consultation service delivery desired by the user, a field in which the user can specify a price range or a maximum price desired by the user for medical consultation, a distance from the user's location within which the user desires to receive medical consultation, one or more medical service types related to the medical condition (e.g., whether a minor issue, generic issue, second opinion, etc.), and the like. Additional fields with which the user may interact to specify the various criteria 215 include, but are not limited to, a field in which the user may specify a response time for a medical practitioner to respond to the user's medical need, a field in which the user specifies one or more medical practitioner types requested by the user (e.g., specialist, general physician, registered nurse, chiropractor, etc.), a field in which the user specifies one or more medical practitioner locations, etc. As the user adjusts the user selection criteria 215, the various options 210 presented in the view 200 can be updated by the options optimizer 190 and/or MMCOO 160 in real time. Thus, the user can adjust user selection criteria 215 to obtain options 210 for medical consultation most preferable to the user. In the example depicted in FIG. 2, an option provided by a particular healthcare provider 240 which best matches the user selection criteria can be presented highest on the list of options 210 and can be visually distinguished from other options 210. For example, each field 220-232 of that option can be highlighted or presented in a different color than the other options 210.

From the various options 210 the user can select a healthcare provider to provide medical consultation. For example, the user can select the healthcare provider 240. Responsive the user selecting the healthcare provider 240, the MMCOO 160 can receive payment from the user in order for the user to access the selected healthcare provider 240. For example, the MMCOO 160 can prompt the user to enter payment information or access the user's payment information from the user's medical case selfie or a user payment profile. Further, the MMCOO 160 can, in real time, communicate the user's medical case selfie to that healthcare provider 240 for the healthcare provider's review in consulting/treating the user. The MMCOO 160 also can establish a communication link, via the healthcare consultation system 130, between the user's client device 110 and a processing system of the healthcare provider 240. That processing system can offer to the user medical consultation services indicated in the options 210 for that healthcare provider 240, which the user can use. Information exchanged between the user and the healthcare provider 240 can be added to the user's medical case selfie. Thus, such information can be available for future healthcare issues of the user.

Further, healthcare providers can be provided limited access to update the user's medical case selfie, for example to indicate medical consultations provided, prescribed medications, testing performed on the user, results of such testing, recommendations made to the user regarding his/her symptoms/ailments, and/or other information. Thus, this information can become part of the user's medical case selfie, and can be reviewed by that healthcare provider or other healthcare providers when providing future medical consultation to the user.

The MMCOO 160 can receive user feedback and/or reviews regarding medical consultations obtained by users using the healthcare consultation system 130. The MMCOO 160 also can gather feedback/reviews from other sources, for example from one or more external systems 140. The MMCOO 160 can present such feedback/reviews to other users using the healthcare consultation system 130. For example, if a user selects the healthcare provider 240, feedback/reviews of that healthcare provider 240 can be presented in the user interface, for example in a pop-up window or in another view. Accordingly, a user can take the feedback/reviews into consideration when determining whether to use medial consultation provided by that healthcare provider.

At any time the user can log back into the healthcare consultation system 130 to update the user's medical case selfie with additional information, for example updates on the user's symptoms and/or ailments, and indication of whether a medical consultation provided to the user was successful at alleviating the user's symptoms and/or ailments, new symptoms and/or ailments experienced by the user, etc. Because the healthcare consultation system 130 persists the user's medical case selfie to the MMCOO database 185, the user's medical case selfie can be maintained indefinitely. Thus, the user need not go through the process of inputting medical history, contact information, etc., each time the user uses the system to seek further medical consultation.

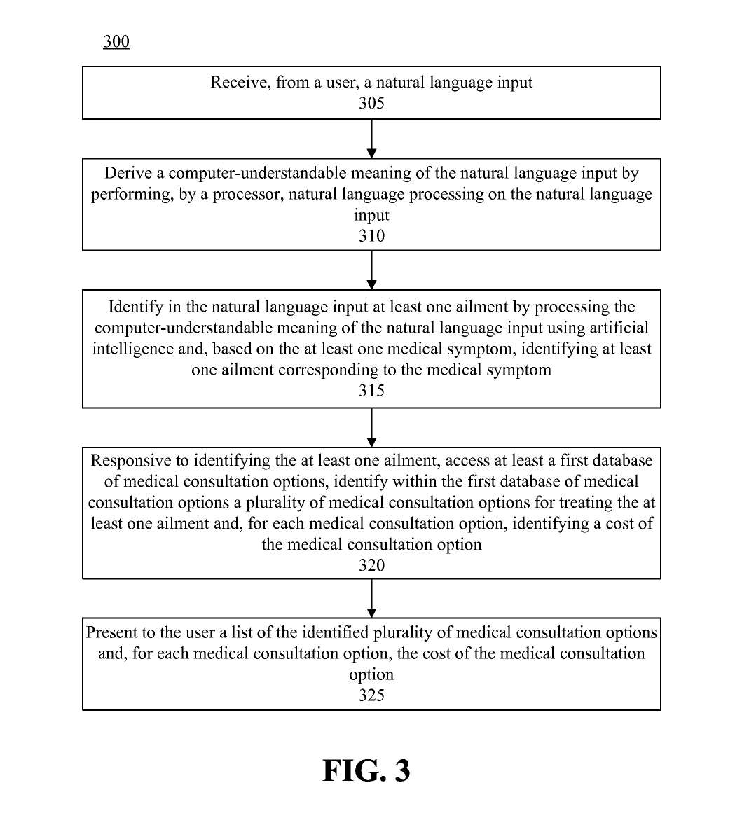

FIG. 3 is a flow chart illustrating an example of a method 300 of presenting to a user a list of a plurality of medical consultation options. At step 305, a natural language input can be received from a user. At step 310, a computer-understandable meaning of the natural language input can be derived by perform, by a processor, natural language processing on the natural language input. At step 315, at least one indicated medical symptom cam be identified in the natural language input by processing the computer-understandable meaning of the natural language input using artificial intelligence. Further, based on the at least one medical symptom, at least one ailment corresponding to the medical symptom can be identified. At step 320, responsive to identifying the at least one ailment, at least a first database of medical consultation options can be accessed. A plurality of medical consultation options for treating the at least one ailment can be identified within the first database of medical consultation options. For each medical consultation option, a cost of the medical consultation option can be identified. At step 325, a list of the identified plurality of medical consultation options can be presented to the user. For each medical consultation option, the cost of the medical consultation option also can be presented.

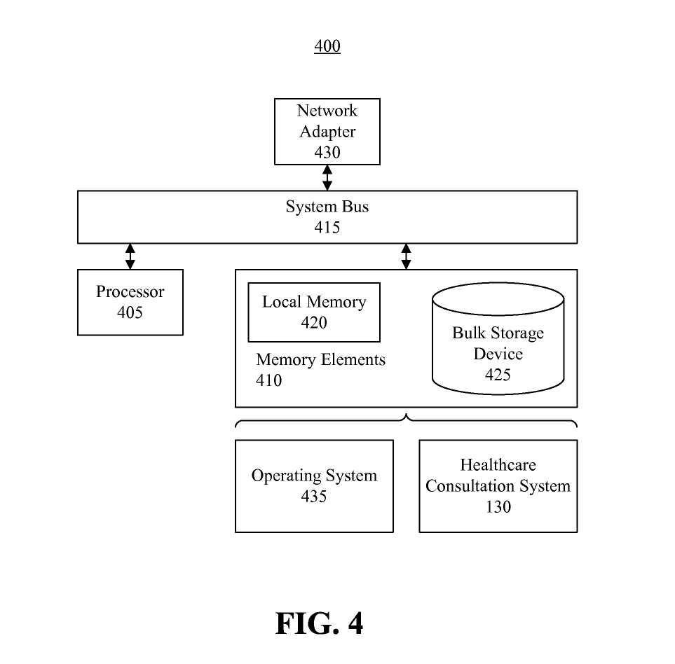

FIG. 4 is a block diagram illustrating example architecture for a data processing system 400 configured to present a list of consultation options to a user in accordance with one or more arrangements disclosed within this specification. For example, the data processing system 400 can host the healthcare consultation system 130 of FIG. 1.

The data processing system 400 can include at least one processor 405 (e.g., a central processing unit) coupled to memory elements 410 through a system bus 415 or other suitable circuitry. As such, the data processing system 400 can store program code within the memory elements 410. The processor 405 can execute the program code accessed from the memory elements 410 via the system bus 415. It should be appreciated that the data processing system 400 can be implemented in the form of any system including a processor and memory that is capable of performing the functions and/or operations described within this specification. For example, the processing system 700 can be implemented as a server, a plurality of communicatively linked servers, or the like.

The memory elements 410 can include one or more physical memory devices such as, for example, local memory 420 and one or more bulk storage devices 425. Local memory 420 refers to random access memory (RAM) or other non-persistent memory device(s) generally used during actual execution of the program code. The bulk storage device(s) 425 can be implemented as a hard disk drive (HDD), solid state drive (SSD), or other persistent data storage device. The data processing system 400 also can include one or more cache memories (not shown) that provide temporary storage of at least some program code in order to reduce the number of times program code must be retrieved from the bulk storage device 425 during execution.

Input/output (I/O) devices, such as a network adapter 430, can be coupled to the data processing system 400. The I/O devices can be coupled to the data processing system 400 either directly or through intervening I/O controllers. The network adapter 430 can enable the data processing system 400 to become coupled to other systems, computer systems, remote printers, and/or remote storage devices through intervening private or public networks. Modems, cable modems, transceivers, and Ethernet cards are examples of different types of network adapters 430 that can be used with the data processing system 400.

As pictured in FIG. 4, the memory elements 410 can store an operating system 435 and the healthcare consultation system 130, including the various components 165-190 of the healthcare consultation system 130. Being implemented in the form of executable program code, the healthcare consultation system 130 can be executed by the data processing system 400 and, as such, can be considered part of the data processing system 400. Moreover, the healthcare consultation system 130 includes functional data structures that impart functionality when employed as part of the data processing system 400 of FIG. 4.

While the disclosure concludes with claims defining novel features, it is believed that the various features described herein will be better understood from a consideration of the description in conjunction with the drawings. The process(es), machine(s), manufacture(s) and any variations thereof described within this disclosure are provided for purposes of illustration. Any specific structural and functional details described are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “includes,” “including,” “comprises,” and/or “comprising,” when used in this disclosure, specify the presence of stated features, integers, steps, operations, elements, and/or components, but do not preclude the presence or addition of one or more other features, integers, steps, operations, elements, components, and/or groups thereof.

Reference throughout this disclosure to “one embodiment,” “an embodiment,” or similar language means that a particular feature, structure, or characteristic described in connection with the embodiment is included in at least one embodiment described within this disclosure. Thus, appearances of the phrases “in one embodiment,” “in an embodiment,” and similar language throughout this disclosure may, but do not necessarily, all refer to the same embodiment.

The term “plurality,” as used herein, is defined as two or more than two. The term “another,” as used herein, is defined as at least a second or more. The term “coupled,” as used herein, is defined as connected, whether directly without any intervening elements or indirectly with one or more intervening elements, unless otherwise indicated. Two elements also can be coupled mechanically, electrically, or communicatively linked through a communication channel, pathway, network, or system. The term “and/or” as used herein refers to and encompasses any and all possible combinations of one or more of the associated listed items. It will also be understood that, although the terms first, second, etc. may be used herein to describe various elements, these elements should not be limited by these terms, as these terms are only used to distinguish one element from another unless stated otherwise or the context indicates otherwise.

The term “if” may be construed to mean “when” or “upon” or “in response to determining” or “in response to detecting,” depending on the context. Similarly, the phrase “if it is determined” or “if [a stated condition or event] is detected” may be construed to mean “upon determining” or “in response to determining” or “upon detecting [the stated condition or event]” or “in response to detecting [the stated condition or event],” depending on the context.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method, comprising:
receiving, from a user, a natural language input;
deriving a computer-understandable meaning of the natural language input by performing, by a processor, natural language processing on the natural language input;
identifying in the natural language input at least one indicated medical symptom by processing the computer-understandable meaning of the natural language input using artificial intelligence and, based on the at least one medical symptom, identifying at least one ailment corresponding to the medical symptom;
responsive to identifying the at least one medical symptom, accessing at least a first database of medical consultation options, identifying within the first database of medical consultation options a plurality of medical consultation options for treating the at least one ailment and, for each medical consultation option, identifying a cost of the medical consultation option; and
presenting to the user a list of the identified plurality of medical consultation options and, for each medical consultation option, the cost of the medical consultation option.

2. The method of claim 1, further comprising:
responsive to identifying in the natural language input at least one ailment, prompting the user to enter additional information to symptoms experienced by the user and medical history of the user; and
processing the additional information using the artificial intelligence; and
based on identifying in the natural language input at least one ailment and processing the additional information using the artificial intelligence, automatically generating a medical case data file for the user, the medical case data file comprising the at least one ailment and the additional information.

3. The method of claim 2, further comprising:
identifying a location of the user; and
responsive to identifying the location of the user, accessing climate data indicating a climate at the location;
wherein the medical case data file further comprises information indicating the climate at the location.

4. The method of claim 2, further comprising:
identifying a location of the user; and
responsive to identifying the location of the user, identifying at least one disease outbreaks within a particular distance of the location by accessing at least a second database of disease outbreaks;
wherein the medical case data file further comprises information indicating the at least one disease outbreak.

5. The method of claim 1, wherein presenting to the user the list of the identified plurality of consultation options comprises presenting to the user a list of healthcare providers.

6. The method of claim 5, wherein presenting to the user the list of healthcare providers comprises presenting, for each healthcare provider, an indication of a type of consultation delivery.

7. The method of claim 1, further comprising:
identifying a plurality of other users afflicted by the ailment; and
presenting to the user and the plurality of other users an option to collectively purchase at least one of the identified plurality of consultation options.

8. A system, comprising:
a processor programmed to initiate executable operations comprising:
receiving, from a user, a natural language input;
deriving a computer-understandable meaning of the natural language input by performing natural language processing on the natural language input;
identifying in the natural language input at least one indicated medical symptom by processing the computer-understandable meaning of the natural language input using artificial intelligence and, based on the at least one medical symptom, identifying at least one ailment corresponding to the medical symptom;
responsive to identifying the at least one medical symptom, accessing at least a first database of medical consultation options, identifying within the first database of medical consultation options a plurality of medical consultation options for treating the at least one ailment and, for each medical consultation option, identifying a cost of the medical consultation option; and
presenting to the user a list of the identified plurality of medical consultation options and, for each medical consultation option, the cost of the medical consultation option.

9. The system of claim 8, the executable operations further comprising:
responsive to identifying in the natural language input at least one ailment, prompting the user to enter additional information to symptoms experienced by the user and medical history of the user; and
processing the additional information using the artificial intelligence; and
based on identifying in the natural language input at least one ailment and processing the additional information using the artificial intelligence, automatically generating a medical case data file for the user, the medical case data file comprising the at least one ailment and the additional information.

10. The system of claim 9, the executable operations further comprising:
identifying a location of the user; and
responsive to identifying the location of the user, accessing climate data indicating a climate at the location;
wherein the medical case data file further comprises information indicating the climate at the location.

11. The system of claim 9, the executable operations further comprising:
identifying a location of the user; and
responsive to identifying the location of the user, identifying at least one disease outbreaks within a particular distance of the location by accessing at least a second database of disease outbreaks;
wherein the medical case data file further comprises information indicating the at least one disease outbreak.

12. The system of claim 8, wherein presenting to the user the list of the identified plurality of consultation options comprises presenting to the user a list of healthcare providers.

13. The system of claim 12, wherein presenting to the user the list of healthcare providers comprises presenting, for each healthcare provider, an indication of a type of consultation delivery.

14. The system of claim 8, the executable operations further comprising:
identifying a plurality of other users afflicted by the ailment; and
presenting to the user and the plurality of other users an option to collectively purchase at least one of the identified plurality of consultation options.

15. A computer program product comprising a computer readable storage medium having program code stored thereon, the program code executable by a processor to perform a method comprising:
receiving, by the processor, from a user, a natural language input;
deriving a computer-understandable meaning of the natural language input by performing, by the processor, natural language processing on the natural language input;
identifying, by the processor, in the natural language input at least one indicated medical symptom by processing, by the processor, the computer-understandable meaning of the natural language input using artificial intelligence and, based on the at least one medical symptom, identifying at least one ailment corresponding to the medical symptom;
responsive to identifying the at least one medical symptom, accessing, by the processor, at least a first database of medical consultation options, identifying, by the processor, within the first database of medical consultation options a plurality of medical consultation options for treating the at least one ailment and, for each medical consultation option, identifying, by the processor, a cost of the medical consultation option; and
presenting, by the processor, to the user a list of the identified plurality of medical consultation options and, for each medical consultation option, the cost of the medical consultation option.

16. The computer program product of claim 15, the method further comprising:
responsive to identifying in the natural language input at least one ailment, prompting the user to enter additional information to symptoms experienced by the user and medical history of the user; and
processing the additional information using the artificial intelligence; and
based on identifying in the natural language input at least one ailment and processing the additional information using the artificial intelligence, automatically generating a medical case data file for the user, the medical case data file comprising the at least one ailment and the additional information.

17. The computer program product of claim 16, the method further comprising:
identifying a location of the user; and
responsive to identifying the location of the user, accessing climate data indicating a climate at the location;
wherein the medical case data file further comprises information indicating the climate at the location.

18. The computer program product of claim 16, the method further comprising:
identifying a location of the user; and
responsive to identifying the location of the user, identifying at least one disease outbreaks within a particular distance of the location by accessing at least a second database of disease outbreaks;
wherein the medical case data file further comprises information indicating the at least one disease outbreak.

19. The computer program product of claim 15, wherein presenting to the user the list of the identified plurality of consultation options comprises presenting to the user a list of healthcare providers.

20. The computer program product of claim 15, the method further comprising:
identifying a plurality of other users afflicted by the ailment; and
presenting to the user and the plurality of other users an option to collectively purchase at least one of the identified plurality of consultation options.
